(19) United States
(12) Patent Application Publication
(10) Pub. No.: US 2005/0105855 A1
(43) Pub. Date: May 19, 2005

(54) Method for constructing an optical beam guide system in a contamination-free atmosphere and universal optical module for said construction

(76) Inventor: Thomas Dressler, Jena (DE)

Correspondence Address: JORDAN AND HAMBURG LLP, 122 EAST 42ND STREET, SUITE 4000, NEW YORK, NY, 10168, US

(21) Appl. No.: 10/501,646

(22) PCT Filed: Dec. 20, 2002
(86) PCT No.: PCT/DE02/04755

(30) Foreign Application Priority Data
Jan. 24, 2002 (DE) 102 03 454.0

(51) Int. Cl. G02B 6/26

(52) U.S. Cl. 385/52

(57) ABSTRACT

The invention relates to a method for constructing an optical beam guide system in a contamination-free atmosphere and a universal optical module for said construction. The aim of the invention is to prevent contamination of the optical imaging elements during handling, assembly and adjustment. According to the invention, the imaging element is fixated aligned relative to a first reference of a support on said support outside the contamination-free atmosphere of the beam guide system, with its optical axis protected against atmospheric influences. The support, protected against atmospheric influences, is introduced into the contamination-free atmosphere of the beam guide system together with the imaging element and is fastened on the recording element, with the first reference aligned with a second reference of a recording element, thereby aligning the optical axis of the imaging element in the beam guide system. The method and the optical module according to the invention are especially suitable for application where optical systems have to be positioned in a beam guide system ready for instantaneous use and protected from environmental influences.

### BACKGROUND

The invention relates to a method for construction of an optical beam guidance system in a contamination-free atmosphere by fitting with optical imaging elements and furthermore relates to a universal optics module with a carrier plate for receiving at least one optical imaging element in a receiving plane.

As is known, in optical lithography chip structures are transferred to a wafer using a mask and light. While special lasers generate the wavelengths necessary for high resolution, high-resolution projection lenses image the structures, whereby the highest resolution lenses contained therein take on increased importance due to the chip structures becoming ever smaller.

The fundamental physical relationship between attainable resolution and the working wavelength of the radiation demands the use of radiation sources with increasingly shorter waves in the DUV, VUV, and, in the future, in the EUV.

With the transition to ever shorter wavelengths, novel materials such as for instance calcium fluoride are necessary that are sufficiently transparent for these wavelengths and that are resistant to the radiation used.

In addition, increasing amounts of gas components in our natural atmosphere (oxygen, water vapor, hydrocarbons) are highly absorbing for the shorter wavelengths and contamination of the optical surfaces with these gas components has a negative effect on the transmission and service life of the optical imaging elements and therefore on transmission in the optical beam path.

For this reason, such optical beam guidance systems must be enclosed in a contamination-free atmosphere in that there is rinsing with ultra-pure gases or the systems are disposed in a vacuum.

In the past there has been no satisfactory solution to the problem of assembly, handling, and in particular alignment of the optical imaging elements under the conditions of a contamination-free atmosphere, which is necessary both during initial construction of an optical beam guidance system and during exchange of individual elements due to indications of wear as a consequence of high laser beam loads.

### SUMMARY

The object of the invention is therefore to solve the existing problem, in particular in terms of avoiding contamination of the optical imaging elements that occurs during handling, assembly, and alignment activities.

In accordance with the invention, this object is achieved using a method of the type cited in the foregoing in that
the imaging element is fixed at its optical axis outside of the contamination-free atmosphere of the beam guidance system, protected from atmospheric influences, in relation to a first reference of a carrier oriented to the carrier, and
in that the carrier together with the imaging element, protected from atmospheric influences, is brought into the contamination-free atmosphere of the beam guidance system, and, with the first reference oriented to a second reference of a receiving element, is attached to the receiving element, whereby the optical axis of the imaging element is oriented in the beam guidance system.

It is of particular advantage when the orientation of the optical axis of the imaging element occurs using an alignment template.

It is also of advantage that cleaning/decontamination of the imaging element and the carrier can be performed outside of the contamination-free atmosphere of the optical beam guidance system.

During the transfer that is protected from environmental influences, the optical imaging element can be assembled, capable of functioning immediately, in the projection beam path of the beam guidance system with high reproducibility of alignment and without realignment being necessary under the conditions there and without additional time-consuming decontamination steps being required. Complex gas-tight and vacuum-tight operations for adjusting elements and time-consuming decontamination processes in the arrangement can thus be avoided.

The carrier with the imaging element can be transferred for instance using a transport container and an airlock system as suggested in DE 101 64 529.5.

Together with the carrier plate, the expensive optical imaging elements stressed by laser irradiation can be exchanged easily and forwarded to a reprocessing procedure. The optical imaging elements stressed by laser irradiation can be repolished and recoated in such a process. The repolished and recoated optical imaging elements can be maintained in a protected manner in a pre-aligned condition so that they are available for re-use in a beam guidance system if needed.

The subject of the invention is furthermore a universal optical module of the type specified in the foregoing in which the carrier plate carries the optical imaging element at its optical axis oriented to one axis with a pre-specified axial direction and the axis has a fixed physical arrangement to a reference joined to the carrier plate, with which the carrier plate can be positioned.

In a pre-specified axial direction that runs perpendicular to the receiving plane, seating surfaces are worked into the carrier plate as references that are oriented to one another in one common plane that is parallel to the receiving plane. It is advantageous when the seating surfaces are sunk into the carrier plate in a triangular formation.

For aligning the optical imaging element, the carrier plate contains at least one adjusting element that engages an adjustable stop torsion-free on the optical imaging element.

The rotational movement and the disruptive effect on the optics resulting therefrom due to the frictional movement on adjacent surfaces as occur in otherwise conventionally used sensitive set screws is avoided in that the adjustable stop is attached to a lever arm of a solid lever that is adjustable relative to a fixed part using an adjusting spindle that engages the lever arm.

The adjusting spindle is pre-stressed and arrested by a compression spring that is supported on the lever arm and on a clamping sleeve that is attached in a spindle bearing in the fixed part. This is advantageous because this joining of the pre-stressed adjusting spindle to the lever arm of the solid lever removes the slack from the spindle. Using this, the adjustable linear position can be achieved in increments of 0.3 to 0.4 mm. Thus, it is particularly advantageous that the optical imaging element can be displaced parallel to the receiving plane of the carrier plate as required for alignment.

Finally, contamination of the optical surface is also prevented in that the adjusting spindle and a fine-pitch thread for engaging the lever arm are provided with a special coating that minimizes friction and that does not release any particles itself and that makes it possible to work without using any lubricants.

The invention is explained in greater detail in the following using the drawings.

### BRIEF DESCRIPTION OF THE DRAWINGS

FIG. 1 is a top view of an optics module with an attached cylinder lens aligned thereupon;

FIG. 2 is a section A-A through the optics module;

FIG. 3 is a top view of an adjusting element for aligning an optical imaging element attached to the optics module;

FIG. 4 is a front elevation of the adjusting element;

FIG. 5 is a section A-A through the adjusting element; and

FIG. 6 is a sectional illustration through a module-type protective housing part for receiving an optical imaging element for a beam guidance system and a transport container docked to the protective housing part.

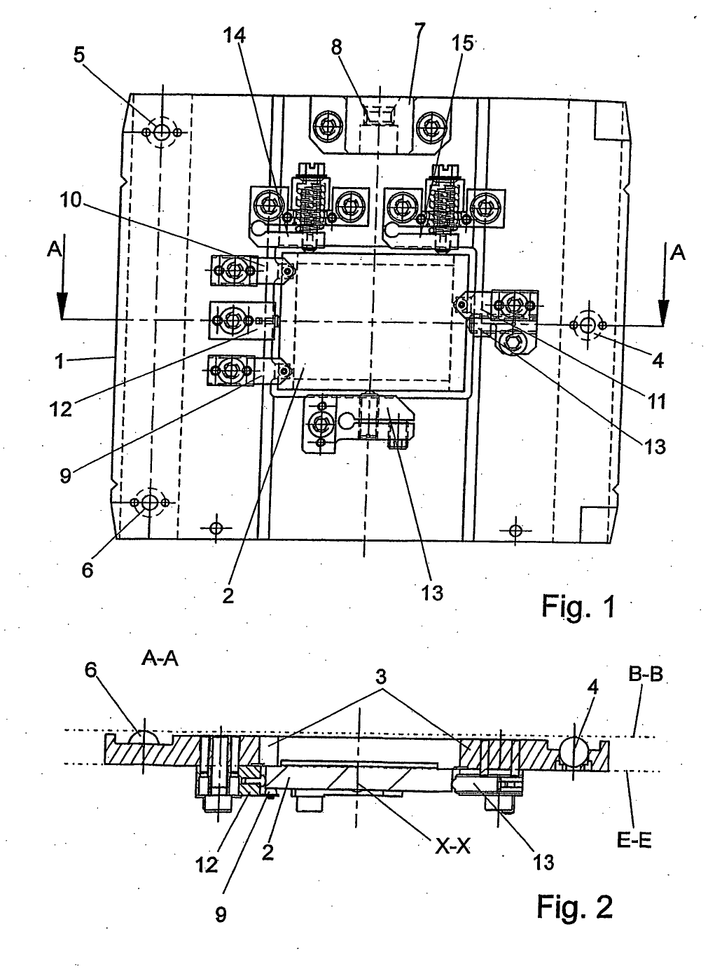

### DETAILED DESCRIPTION

In accordance with the invention, the universal optics carrier illustrated in FIG. 1 is provided for receiving on a carrier plate 1 an optical imaging element 2, such as for instance an optical imaging and beam-shaping spherical or cylindrical lens or in particular also an asymmetrical imaging element, and for fitting a projection beam path enclosed by a contamination-free atmosphere.

Of course the optics module is also suitable for other optical imaging elements such as for instance screens, grids, prisms, mirrors, and beam splitters or other testing tools as well as sensors.

For this purpose, the optical imaging element 2 is oriented outside of the contamination-free atmosphere of the beam guidance system at its optical axis protected from atmospheric influences by means of an alignment apparatus (not shown) using an alignment template to an axis X-X with a pre-specified axial direction that is in a fixed physical relationship to a reference associated with the carrier plate 1 and that runs perpendicular to a receiving plane E-E in which are arranged the supports 3 for the optical imaging element 2. In the present exemplary embodiment, the reference is embodied by seating surfaces 4, 5, 6 that are oriented to one another and that are sunk as spheres in a triangular formation into the carrier plate 1 in a common plane B-B that is parallel to the receiving plane E-E. The spherically embodied seating surfaces 4, 5, and 6 position the carrier plate 1 both with respect to the alignment template in the alignment apparatus and also during assembly of the carrier plate 1 in the beam guidance system. Provided on the carrier plate 1 is an attaching element 7 with worked-in screw thread 8 for a manipulator (not shown) with which the carrier plate 1 with the attached optical imaging element 2 aligned thereupon can be transferred for instance from a storage and transport container through an airlock system into the clean room of a semiconductor processing facility and positioned there in a projection beam path in an operating condition.

The carrier plate 1 contains attaching and adjusting elements in the form of fixed stops, in the form of holding elements that are embodied resilient in the pre-specified axial direction or perpendicular thereto, and in the form of adjustable stops for orienting the optical imaging element 2. In the present case, the cylinder lens is held on the supports 3 by the holding elements 9, 10, and 11 that are embodied resilient in the axial direction X-X and is adjacent to a fixed stop 12 and to the stops 13 that are embodied resilient perpendicular to the pre-specified axial direction. Displacement parallel to the receiving plane E-E is performed by adjusting elements 14 and 15, in which adjustable stops resiliently directly engage the optical imaging element 2 as a result the action of the resilient stops 13. Thus low-tension mounting of the optical imaging element 2 is possible.

The arrangement and the number of attaching and adjusting elements is not limited to the configuration describe herein and is determined by the optical element to be attached aligned and the intended displacements, in particular by the shape of the imaging element, which can be symmetrical or asymmetrical. However, the arrangement can always be selected such that the optical surfaces can be touched up without changing the geometry of the clamping surfaces. This is necessary if the optical surfaces become inappropriate for the imaging requirements as a result of high laser beam loads.

Furthermore, in a suitable arrangement of the attaching and adjusting elements, it is possible to align not only in the radial direction, but also in the axial direction.

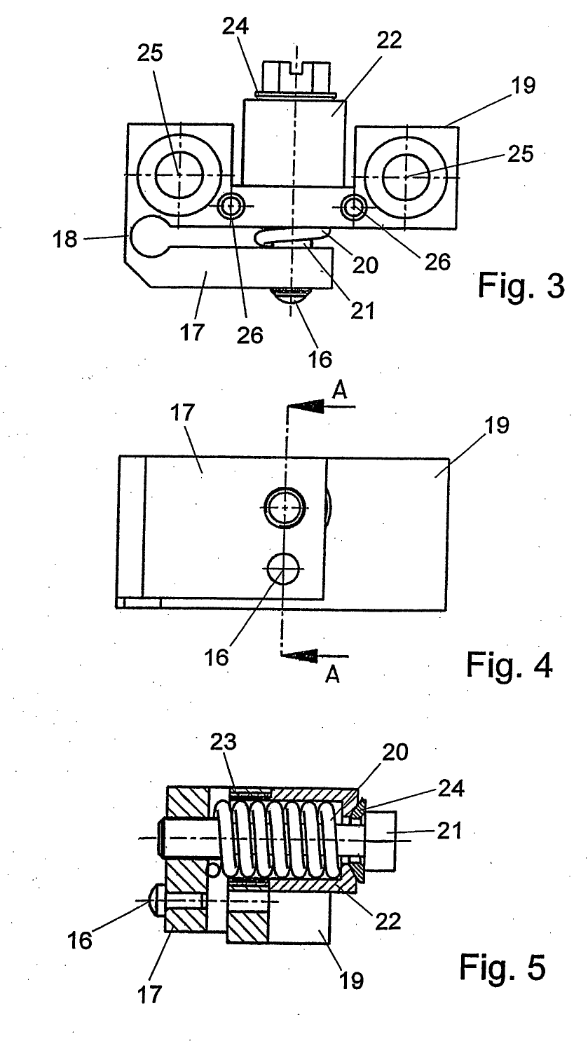

The structure of the adjusting element, illustrated in FIGS. 3 through 5, at least one of which is used for aligning the optical imaging element 2 on the carrier plate 1, has an adjustable stop 16 that can engage the optical imaging element 2 torsion-free. This freedom from torsion is achieved in that the stop 16 is attached to a lever arm 17 of a solid lever 18 that is adjustable, relative to a fixed part 19 to be attached to the carrier plate 1, using an adjusting spindle 21 that is screwed into the lever arm 17 and axially pre-stressed and arrested by a compression spring 20. The compression spring 20 is supported on the lever arm 17 and on a clamping sleeve 22 that is fastened in a spindle bearing 23 in the fixed part 19. The stop 16, axially displaced to the adjusting spindle 19, is pressed into the lever arm 17. A spherical disk 24 arranged between the adjusting spindle 21 and the clamping sleeve 22 equalizes the movement of the lever arm 17 via the solid lever 18. The fixed part 19 is attached to the carrier plate 1 with the sink bores 25 and pin bores 26.

The adjusting spindle 21 and the fine-pitch thread into which the adjusting spindle 21 is screwed are provided with a non-gassing special coating (e.g., DNC surface coating) with which frictional forces are minimized and work can be performed without lubricants.

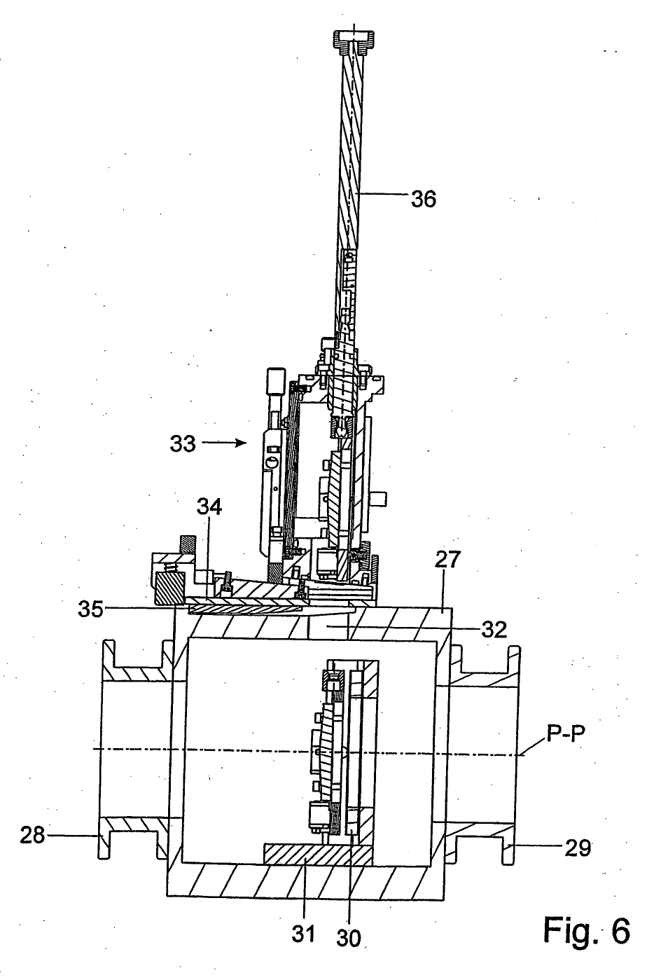

The modularly embodied protective housing part 27 illustrated in FIG. 6 is provided for receiving at least one universal optics module with the imaging element 2 situated therein aligned with its optical axis, whereby laterally situated flanges 28, 29 permit a plurality of such protective housing parts 27 to be joined to one another or permit the protective housing part to be sealed gas-tight with at least one input or output window in order to create an optical beam guidance system enclosed by a contamination-free atmosphere with a projection beam path P-P guided centrally through the flanges 28, 29.

Within the protective housing part 27, a receiving element 30 with a second reference is provided for each optics module that the second reference is designed congruent to the spherical seating surfaces 4, 5, and 6 and that has, in a triangle symmetrical to the projection beam path P-P, one prismatic, one planar, and one spherical seating element.

In the present exemplary embodiment, the receiving element 30 is attached to a housing-fixed angle 31, but it can also be alignable using a displacement option for the angle 1.

For transferring the optics module into the projection beam path P-P and out of it again while protecting it from atmospheric influences, the protective housing part 27 is equipped with an air-lock opening 32 and a receiving plate 34 as an interface for a transport container 33, to which the receiving plate the transport container 33 can be docked in the manner illustrated in FIG. 3. The air-lock opening 32 has a lock 35 that can be displaced with a carrier on the transport container 33 once placed thereupon. The optics module can be transferred in a direction perpendicular to the projection beam path P-P using a manipulator 36.

1. A method for construction of an optical beam guidance system in a contamination-free atmosphere by fitting with optical imaging elements, characterized in that
said imaging element is fixed at its optical axis outside of said contamination-free atmosphere of said beam guidance system, protected from atmospheric influences, in relation to a first reference of a carrier oriented to said carrier, and
in that said carrier together with said imaging element, protected from atmospheric influences, is brought into said contamination-free atmosphere of said beam guidance system, and, with said first reference oriented to a second reference of a receiving element, is attached to said receiving element, whereby the optical axis of said imaging element is oriented in said beam guidance system.

2. The method in accordance with claim 1, characterized in that the orientation of said optical axis of said imaging element occurs using an alignment template.

3. The method in accordance with claim 1, wherein cleaning/decontamination of said imaging element and said carrier is performed outside of said contamination-free atmosphere of said optical beam guidance system.

4. An universal optics module with a carrier plate for receiving at least one optical imaging element in a receiving plane (E-E), wherein said carrier plate carries said optical imaging element at its optical axis oriented to one axis (X-X) with a pre-specified axial direction and said axis (X-X) has a fixed physical arrangement to a reference joined to said carrier plate, with which said carrier plate can be positioned.

5. An optics module in accordance with claim 4, characterized in that said axis (X-X) runs perpendicular to said receiving plane (E-E) and seating surfaces are worked into said carrier plate as references that concentrically enclose said axis (X-X) in a common plane (B-B) that is parallel to said receiving plane (E-E).

6. Optics An optics module in accordance with claim 5, characterized in that said seating surfaces are sunk into said carrier plate in a triangular formation.

7. An optics module in accordance with claim 4, wherein for aligning said optical imaging element said carrier plate contains at least one adjusting element that engages an adjustable stop torsion-free on said optical imaging element.

8. An optics module in accordance with claim 7, wherein said adjustable stop is attached to a lever arm of a solid lever that is adjustable relative to a fixed part using an adjusting spindle that engages said lever arm.

9. An optics module in accordance with claim 8, wherein said adjusting spindle is pre-stressed and arrested by a compression spring that is supported on said lever arm and on a clamping sleeve that is attached in a spindle bearing in said fixed part.

10. An optics module in accordance with claim 9, characterized in that said adjusting spindle and a fine-pitch thread for engaging said lever arm are provided with a special coating that minimizes friction.

11. An optics module carrier in accordance with claim 4, wherein said optical imaging element can be displaced parallel to said receiving plane (E-E) of said carrier plate as required for alignment.
